(19) United States
(12) Patent Application Publication
(10) Pub. No.: US 2013/0305856 A1
(43) Pub. Date: Nov. 21, 2013

(54) ACTUATOR

(71) Applicant: Milan Klimes, Niles, MI (US)

(72) Inventor: Milan Klimes, Niles, MI (US)

(21) Appl. No.: 13/829,758

(22) Filed: Mar. 14, 2013

Related U.S. Application Data
(60) Provisional application No. 61/647,355, filed on May 15, 2012.

(51) Int. Cl. F16H 1/20

(52) U.S. Cl. CPC F16H 1/20
USPC 74/89.16

(57) ABSTRACT

An actuator comprising a housing for a motor assembly including a rotatable motor pinion and a stator, a gear assembly including rotatable first, second, and third gears, and a sensor assembly. The motor pinion and the second gear are both mounted to the same shaft in the housing. The first gear s coupled to both the motor pinion and the second gear and the third gear is coupled to the second gear and defines an aperture adapted to receive the rotatable shaft of a vehicle part. In one embodiment, the third gear is a sector gear and a pair of washers and a bushing mount the sector gear for rotation in the housing.

### CROSS-REFERENCE TO RELATED APPLICATIONS

This application claims the benefit of the filing date and disclosure of U.S. Provisional Application Ser. No. 61/647,355, filed on May 15, 2012 which is explicitly incorporated herein by reference as are all references cited therein.

### FIELD OF THE INVENTION

The present invention relates to actuators in general and, in particular, to a rotary actuator.

### BACKGROUND OF THE INVENTION

This invention relates to an actuator which can be used in a wide variety of applications to control the rotary motion of an apparatus or part including, for example, valves, switches, and indicators. An actuator of the type forming the subject of this invention includes three main components: an electric motor assembly including a rotor and a stator; a gear assembly which couples the rotor of the motor to the rotatable shaft of the apparatus or part; and a sensor and control assembly.

The present invention addresses the continued need for an actuator with a reduced number of component parts and of reduced cost.

### SUMMARY OF THE INVENTION

The present invention is generally directed to an actuator which comprises a housing; a combination motor and gear shaft secured in the housing; a motor assembly in the housing which includes a rotatable motor pinion mounted to the combination motor and gear shaft for rotation relative thereto, and a stator surrounding and spaced from the motor pinion; a gear assembly which includes a first rotatable gear coupled to the motor pinion, a second rotatable gear mounted to the combination motor and gear shaft and coupled to the first rotatable gear, and a third rotatable gear coupled to the second rotatable gear and defining an aperture adapted to receive a rotatable shaft; and a sensor assembly which includes a circuit board mounted in the housing.

In one embodiment, the motor pinion includes a shaft with gear teeth, and each of the first and second gears includes a wheel with gear teeth and a shaft with gear teeth, and the third gear is a sector gear with gear teeth, the gear teeth on the shaft of the motor pinion being coupled to the gear teeth on the wheel of the first gear, the gear teeth on the shaft of the first gear being coupled to the gear teeth on the wheel of the second gear and the gear teeth on the shaft of the second gear being coupled to the teeth on the sector gear.

In one embodiment, the circuit board is located in the housing between the stator of the motor assembly and the first gear.

In one embodiment, the motor pinion includes a motor magnet and a yoke molded therein.

In one embodiment the first gear is mounted to a gear shaft which is mounted in the housing.

In one embodiment, a pair of washers and a bushing in the housing mount the third gear for rotation in the housing.

The present invention is also directed to an actuator which comprises a housing, a stationary shaft in the housing, a motor in the housing which includes a stator and a motor pinion mounted for rotation on the shaft in the housing, the stator surrounding the motor pinion, a gear mounted for rotation on the stationary shaft in the housing; and a sensor assembly in the housing.

In one embodiment, the motor pinion includes a yoke, a motor magnet surrounding the yoke, and a sensor magnet.

In one embodiment, the yoke and the motor magnet are molded in a bracket on the motor pinion and the sensor magnet is seated on the bracket.

In one embodiment, the actuator comprises first, second, and third rotatable gears in the housing, the gear comprising the second rotatable gear, the first rotatable gear being located in the housing on one side of the shaft and coupled to the motor pinion and the second rotatable gear, the third rotatable gear located in the housing on another side of the shaft and coupled to the second rotatable gear.

In one embodiment, each of the first and second rotatable gears includes a gear wheel and a collar and the motor pinion includes a shaft, the gear wheel of the first gear being coupled to the shaft of the motor pinion and the gear wheel of the second gear being coupled to the collar of the first gear, the third rotatable gear being coupled to the collar of the second gear.

In one embodiment, the sensor assembly includes a substrate with a sensor, the sensor being located in a relationship opposite and spaced from the sensor magnet on the motor pinion.

In one embodiment, the motor pinion includes a shaft, the shaft extending through an opening defined in the substrate.

In one embodiment, the first, second, and third rotatable gears are all located in the housing above the substrate.

There are other advantages and features of this invention which will be more readily apparent from the following detailed description of the embodiment of the invention, the drawings, and the appended claims.

### BRIEF DESCRIPTION OF THE DRAWINGS

In the accompanying drawings that form part of the specification, and in which like numerals are employed to designate like parts throughout the same:

FIG. 1 is a perspective view of an actuator in accordance with the present invention;

FIG. 2 is a top plan view of the actuator shown in FIG. 1 with the cover removed;

FIG. 3 is a vertical cross-sectional view of the actuator shown in FIG. 1;

FIG. 4 is a perspective view of the motor pinion of the motor assembly of the actuator shown in FIG. 1;

FIG. 5 is a vertical cross-sectional view of the motor pinion shown in FIG. 4;

FIG. 6 is a perspective view of the sensor magnet of the motor pinion shown in FIGS. 4 and 5;

FIG. 7 is a perspective view of the motor magnet of the motor pinion shown in FIGS. 4 and 5; and

FIG. 8 is a perspective view of the yoke of the motor pinion shown in FIGS. 4 and 5.

### DETAILED DESCRIPTION OF THE EMBODIMENT

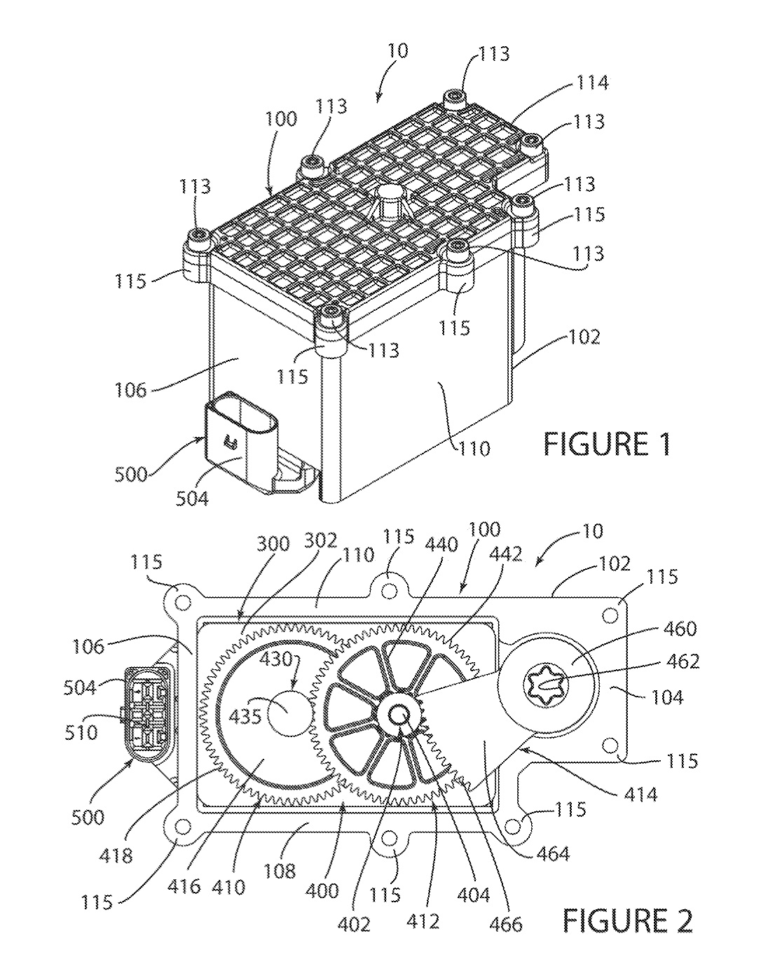

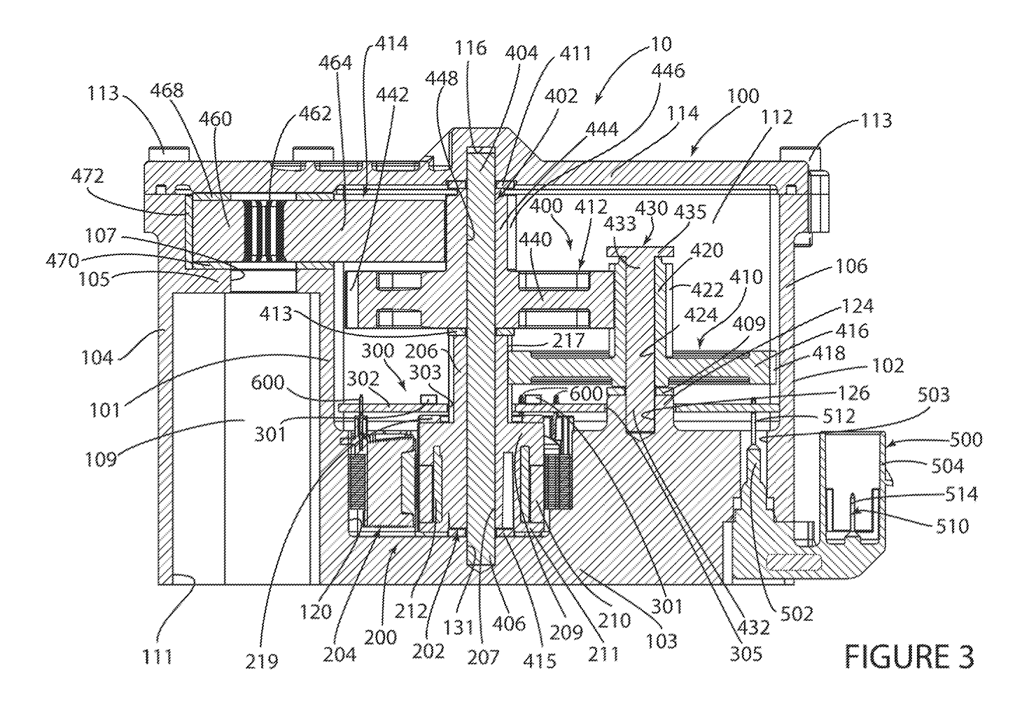

FIGS. 1, 2, and 3 depict a rotary actuator 10 in accordance with the present invention which comprises a housing 100 having a motor assembly 200 (FIG. 3), a circuit board and control assembly 300, and a gear assembly 400 (FIGS. 2 and 3) located and mounted in the housing 100 as described in more detail below.

The actuator 10 can be used in a wide variety of applications to control the rotary motion of an apparatus or part coupled thereto including, for example, to control the rotary motion of the cross shaft (not shown) of a vehicle turbocharger assembly (not shown).

The housing 100, which is preferably made of metal, includes a base 102 that defines an interior receptacle 112 (FIG. 3) and includes a floor 103 (FIG. 3) and a plurality of side walls 104, 106, 108, 110 extending unitarily generally normally upwardly from the peripheral edge of the floor 103 and together defining the interior cavity or receptacle 112 (FIG. 3) which houses the motor assembly 200, the circuit board and control assembly 300, and the gear assembly 400 as described in more detail below.

The housing 100 still further includes a removable plate or cover 114 which may be made of plastic or the like material and which is seated over the top peripheral edge of the side walls 104, 106, 108, and 110 of the base 102 and covers the cavity 112 of the housing 100. A plurality of screws 113 extend through the cover 114 and into the respective apertures defined in respective brackets 115 protruding outwardly from the upper peripheral edge of the side walls 104, 106, 108 and 110 for securing the cover 114 to the base 102 of the housing 100.

As shown in FIG. 3, the cover 114 includes an interior surface defining a generally cylindrically-shaped interior aperture or cavity 116 adapted to receive and secure the end of the shaft 402 of the motor assembly 200 as described in more detail below.

The floor 103 of the base 102 of the housing 100 defines an interior aperture or cavity 120 (FIG. 3) for the motor assembly 200 and a sleeve or bracket 124 (FIG. 3) defining a central aperture 126 (FIG. 3) for receiving and securing the end of a shaft 430 of the gear assembly 400 as described in more detail below.

As shown in FIG. 3, the base 102 of the housing 100 still further includes an interior vertical wall 101 in the interior cavity 112 that extends upwardly from the floor 103 in the direction of the cover 114 in a relationship spaced from and parallel to the side wall 104 of the base 102 of the housing 100. A horizontal ledge or wall 105 in the interior cavity 112 extends between the side wall 104 and the top edge of the interior vertical wall 101 in a relationship spaced from and generally parallel to the cover 114. The horizontal ledge or wall 105 defines a through-aperture 107. The side wall 104, the interior vertical wall 101, and the horizontal ledge 105 in combination define an interior elongate vertically oriented cavity 109 in the base 102 and an opening 111 in the floor 103 of the base 102 that is in communication with the cavity 109.

The actuator 10 further comprises an electrical connector assembly 500 which is an element separate from the housing 100 and includes a first interior end or portion 502 (FIG. 3) extending into another cavity 503 that is defined in the floor 103 of the base 102 of the housing 100 and is in communication with the interior cavity 112 and a second exterior end or portion defining an open terminal receptacle or housing 504 (FIG. 3) extending and protruding outwardly from the exterior of the housing 100 and, more specifically, extending and protruding outwardly from the lower edge of the side wall 106 of the housing 100 adjacent the floor 103 of the base 102 of the housing 100.

The connector assembly 500 includes a plurality of terminals 510 (FIGS. 2 and 3), extending therethrough and having a first end 512 (FIG. 3) protruding outwardly from the first end 502 of the connector assembly 500 into the cavity 112 of the housing 100 (and into and through the substrate 302 and an opposite second end 514 (FIG. 3) protruding into and located in the terminal receptacle 504 of the connector assembly 500.

The electric motor assembly 200 includes a rotor in the form of a motor pinion 202 (FIGS. 3, 4, 5, and 6) and a stator assembly 204 (FIG. 3), both located in the cavity 120 that is defined and formed in the floor 103 of the base 102 of the housing 100.

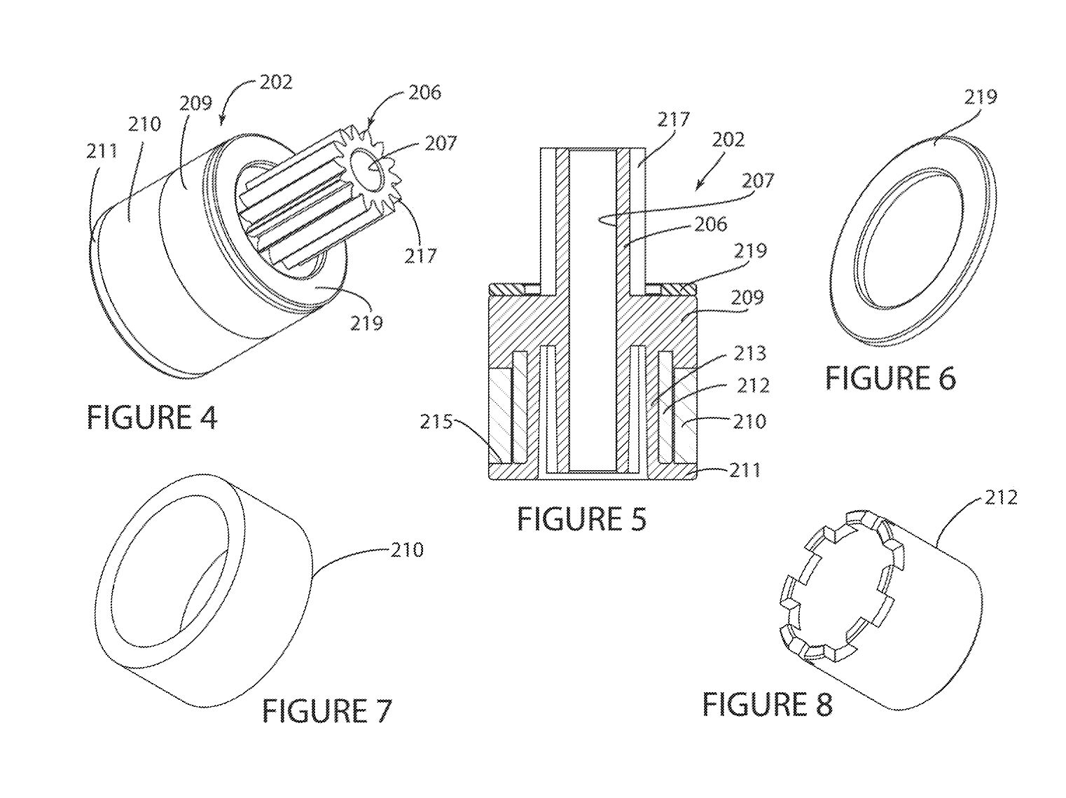

The motor pinion 202, as shown in more detail in FIGS. 4, 5, and 6, is preferably made of a plastic or the like material and, in the embodiment shown, includes a central generally cylindrical tubular shaft or collar 206 defining an interior through-aperture 207.

The central shaft 206 includes a pair of circumferentially extending radial flanges 209 and 211 projecting and protruding unitarily outwardly from the shaft 206. The flange 211 surrounds a lower end of the shaft 206 and the flange 209 surrounds a mid-portion of the shaft 206. A circumferential wall 213 extends between the flanges 209 and 211 in a relationship surrounding and spaced from the exterior surface of the shaft 206. The flanges 209 and 211 and the wall 213 in combination define a bracket and receptacle 215 for a motor yoke 212 and a motor magnet 210.

In the embodiment shown, the flange 209 projects unitarily outwardly fro the exterior surface of the shaft 206 and the flange 211 projects unitarily outwardly from the lower peripheral exterior surface of the wall 213.

The motor pinion 202 also includes a generally tubular motor magnet 210 and a generally tubular and crown-shaped magnet yoke 212. The yoke 212 is overmolded in the recess or bracket 215 in a relationship surrounding and spaced from the shaft 206 and abutting against the wall 213, and the motor magnet 210 is overmolded in the recess or bracket 215 in a relationship surrounding and abutting against the exterior surface of the yoke 212.

An upper portion of the exterior surface of the shaft 206 includes a plurality of vertically oriented gear teeth 217 (FIGS. 3, 4, and 5) formed thereon.

The motor pinion 202 still further includes a generally ring-shaped sensor magnet 219 surrounding and spaced from the shaft 206 and seated against the exterior top surface of the flange 209.

As shown in FIG. 3, the gear assembly 400 includes an elongate combination motor and gear shaft 402 located and mounted centrally in the interior of the cavity 112 of the housing 100 in a generally vertical and normal relationship relative to the floor 103 of the base 206 and the cover 114 of the housing 100 wherein a first upper end 404 of the shaft 402 is secured in the aperture 116 defined in the interior surface of the cover 114 of the housing 100 and a lower end 406 is secured in another recess 131 defined in the floor 103 of the base 102 that is located at the bottom of the motor recess 120 defined in the floor 103 of the base 102 of the housing 100.

As shown in FIG. 3, the motor pinion 202 is located in the recess 120 defined in the floor 103 of the base 102 of the housing 100 in a relationship surrounding, and rotatable relative to, the shaft 402.

The motor assembly 200 further includes the stator assembly 204 which is also located and mounted in the recess 120 defined in the floor 103 of the base 102 of the housing 100 in a relationship surrounding and spaced from the motor pinion 202.

The circuit board and control assembly 300 comprises a plurality of elements including, for example, magnetic field sensors such as Hall effect sensors 301 (FIG. 3), a processor or controller (not shown), and other passive and active electronic components (not shown) mounted on one or both opposite sides of a generally flat printed circuit board or substrate 302 which is located and mounted in the cavity 112 of the housing 100 in a relationship opposed, spaced from, and generally parallel to the exterior surface of the floor 103 of the base 102 of the housing 100 and, more specifically, in a relationship spaced from and above the motor assembly 300 wherein the toothed portion of the shaft 206 of the motor pinion 202 located above the flange 209 thereof extends through a through-aperture 303 defined in the substrate 202 and wherein the sleeve 124 in the floor 103 extends through another aperture 305 defined in the substrate 202.

In the embodiment shown, the magnetic field sensors 301 are seated and coupled to the upper surface of the substrate 302 and positioned in a relationship above, spaced from, and generally opposite the top surface of the ring shaped sensor magnet 219 on the motor pinion 202. Further, in the embodiment shown, the control assembly 300 incorporates three such sensors 301 that are positioned in a circumferential relationship around the through-aperture 303 in the substrate 202 and thus are also positioned in a circumferential relationship surrounding the combination gear/motor pinion shaft 404 and the shaft 206 of the motor pinion 202 extending through the through-aperture 303. In the embodiment shown, the three sensors 301 are spaced one hundred and twenty degrees from each other. Only two of the three such sensors 301 are visible in FIG. 3.

In the embodiment shown, the board 302 extends horizontally from a point adjacent the interior surface of the interior vertical wall 101 in the base 102 of the housing 100 to a point adjacent the interior surface of the side wall 102 of the base 102 of the housing 100.

A plurality of stator terminals, only three such terminals 600 being shown in FIG. 3, extend between the stator assembly 204 and into and through the surface of the board 302.

The gear assembly 400 also includes two intermediate gears 410 and 412 and an output sector gear 414 all located and mounted in the cavity 112 of the housing 100 and coupled together for rotation as described in more detail below.

The intermediate gear 410, as shown in FIGS. 2 and 3, is preferably made of plastic or the like material and includes a wheel 416 with peripheral and circumferentially extending gear teeth 418 formed thereon and an elongate tubular hollow shaft or collar 420 (FIG. 3) extending unitarily upwardly and normally outwardly and centrally from the top surface of the wheel 416 and including an outer surface with a plurality of ear teeth 422 (FIG. 3) formed thereon.

The intermediate gear 410 additionally defines a through-aperture 424 (FIG. 3) extending centrally through the interior of the tubular collar 420 and the wheel 416.

The gear assembly 400 also includes an elongate I-shaft 430 (FIGS. 2 and 3) extending through the intermediate gear 410 and, more specifically, through the central through-aperture 424 defined therein in a relationship normal to the floor 103 of the housing 100 and spaced and generally parallel to the shaft 402.

The I-shaft 430 includes a lower end 432 (FIG. 3) and an upper end 433 (FIG. 3) having a horizontal flange or cap 435 (FIGS. 2 and 3) formed thereon which holds the intermediate gear 410 on the I-shaft 430.

The intermediate gear 410 and the shaft 430 are located and mounted in the housing 100 in a relationship wherein the lower end 432 of the shaft 430 is received and secured in the aperture 126 of the sleeve 124 in the floor 103 of the base 102 of the housing 100; the gear 410 is rotatable relative to the shaft 430; the wheel 416 of the intermediate gear 410 is positioned in a relationship opposed, spaced from, and generally parallel to the floor 103 of the base 102 of the housing 100 and, more specifically, in a relationship opposed, spaced from, generally parallel to, and above the top surface of the printed circuit board 302; and the gear teeth 418 on the wheel 416 are disposed in a relationship coupled and meshed to the gear teeth 217 on the shaft 206 of the motor pinion 202 of the motor assembly 200.

A bushing 409 surrounds the I-shaft 430 and is located between, and in a relationship abutting, the lower outer surface of the gear wheel 416 and the outer surface of the bracket or sleeve 124 formed in the floor 103 of the base 102 of the housing 100.

The intermediate gear 412 is similar in structure to the intermediate gear 410 and thus includes a wheel 440 with peripheral and circumferentially extending gear teeth 442 formed thereon and an elongate tubular hollow shaft or collar 444 (FIG. 3) extending unitarily upwardly and normally outwardly and centrally from the top surface of the wheel 440 and including an outer surface with a plurality of gear teeth 446 (FIG. 3) formed thereon.

The intermediate gear 412 additionally defines a through-aperture 448 (FIG. 3) extending centrally through the interior of the collar 444 and the wheel 440.

The intermediate gear 412 is mounted to the combination gear/motor shaft 402 in the cavity 112 of the housing 100 in a relationship surrounding and rotatable relative to the shaft 402 and is located in the cavity 112 of the housing 100 between the top of the shaft 208 of the motor pinion 202 and the interior face of the cover 114 of the housing 100 and further in a relationship wherein the wheel 440 thereof is located opposed, spaced from, and above the wheel 416 of the intermediate gear 410 with the gear teeth 442 on the wheel 440 of the intermediate gear 412 in coupling and meshed relationship with the gear teeth 422 on the collar 420 of the intermediate gear 410.

Thus, in the embodiment shown, both the motor pinion 202 and the intermediate gear 412 are mounted to the same shaft 402 in a stacked relationship wherein the intermediate gear 412 is located above the motor pinion 202.

Respective bushings 411, 413, and 415 surround the shaft 402. Bushing 411 is located between and in a relationship abutting the top surface of the upper end of the gear collar 444 and the interior surface of the cover 114. Bushing 413 is located between and in a relationship abutting the lower surface of the gear wheel 440 and the upper surface of the upper end of the motor pinion shaft 206. Bushing 415 is located between and in a relationship abutting the outer surface of the lower end of the motor pinion shaft 206 and the interior surface of the floor 103 of the base 102 of the housing 100.

The sector gear 414 includes a generally cylindrically-shaped base 460 defining a generally star-shaped central aperture 462 and a generally fan-shaped sector portion 464 with a peripheral outer face or edge including a plurality of sector gear teeth 466 (FIG. 2) formed thereon.

The aperture 462 is adapted to receive the end of the shaft of the apparatus or part to be rotated including, for example, the rotatable cross shaft (not shown) of a vehicle turbocharger assembly not shown) adapted to extend vertically through the opening 111 in the floor 103 of the base 102, through the interior cavity 109, through the aperture 107 defined in the horizontal wall 105, and into the star-shaped aperture 462 of the sector gear 414.

The sector gear 414 is located and mounted for rotation in the housing 100 by means of a pair of washers 468 and 470 and a sector bushing 472.

As shown in FIG. 3, the sector bushing 472, which is generally arcuate in shape and follows the contour of the base 460 of the sector gear 414, is located in the housing 100 between the interior surface of the housing wall 104 and the exterior surface of the base 460 of the sector gear 414; the washer 468 is located between the upper surface of the horizontal wall 105 of the housing 100 and the lower surface of the base 460 of the sector gear 414; and the washer 470 is located between the upper surface of the base 460 of the sector gear 414 and the interior surface of the cover 114 of the housing 100 to allow and provide for the rotation of the base 460 and thus the rotation of the sector gear 414 in the base 102 of the housing 100.

As further shown in FIG. 2, the fan portion 464 of the sector gear 414 is located in the cavity 112 of the housing 100 in a relationship opposed, above, spaced from, and generally parallel to, the wheel 440 of the intermediate gear 412 with the gear teeth 466 on the fan portion 464 of the sector gear 414 in coupling and meshed relationship with the gear teeth 446 on the outer surface of the shaft 444 of the intermediate gear 412.

Thus, in the embodiment shown, the gear 412 is located in the cavity 112 of the housing 100 on one side of the shaft 402 and the gear 414 is located in the cavity 112 of the housing 100 on the opposed other side of the shaft 402. Further, in the embodiment shown, the gear wheel 412 of the gear 410 is located in the housing 100 above the gear wheel 416 and the motor gear 414 is located in the housing 100 above the gear wheel 440 of the gear 412. Thus, further in the embodiment shown, the gears 410, 412, and 414 are all located in the cavity 112 of the housing 100 above the substrate 302 and the sensor 301.

Thus, still further in the embodiment shown, the motor pinion 202, the respective gears 410, 412, and 414, and the respective shafts 402 and 430 are mounted in and to the housing 100 and coupled to each other in a relationship wherein: the sleeve 124 in the floor 103 of the housing 100 defines an axial end stop that limits the axial, vertical travel of the gear 410 in the direction of the floor 103 and the cap 435 on the I-shaft 430 limits the axial, vertical travel of the gear 410 in the direction of the cover 114; the abutment of the motor pinion 202 against the interior surface of the floor 103 limits the axial, vertical travel of the motor pinion 202 in the direction of the floor 103 and the abutment of the motor pinion 202 against the lower surface of the gear 412 limits the axial, vertical travel of the motor pinion 202 in the direction of the cover 114; the positioning of the gear 412 on the shaft 402 between the motor pinion 202 and the cover 114 limits the axial, vertical travel of the gear 412 in the direction of the floor 103 and the cover 114; and the positioning of the sector gear 414 between the interior housing wall 105 and the cover 114 limits the axial, vertical travel of the sector gear 114 in the direction of the floor 103 and the cover 114.

During operation, the Hall effect sensor 301 senses the magnetic field generated by the motor magnet 210 and provides a signal representative of the position of the motor pinion 202 to the processor which regulates, commutates, or switches the direction of current passing through the appropriate windings of the stator assembly 204 of the motor assembly 200 such that each respective column is switched at the right time to become a north or south electromagnet thereof attracting or repelling the motor magnet 210 and causing the motor pinion 202 to rotate.

The rotation of the motor pinion 202 drives and causes the rotation of the intermediate gear 410 coupled thereto which, in turn, drives and causes the rotation of the intermediate gear 412 coupled to the intermediate gear 410 which, in turn, drives and causes the rotation of the sector gear 414 coupled to the intermediate gear 412 which, in turn, drives and causes the rotation of the rotatable shaft of an apparatus or part such as, for example, the rotatable cross shaft (not shown) of a vehicle turbocharger assembly (not shown).

Numerous variations and modifications of the embodiment described above may be effected without departing from the spirit and scope of the novel features of the invention. It is thus understood that no limitations with respect to the actuator illustrated herein are intended or should be inferred. It is, of course, intended to cover by the appended claims all such modifications as fall within the scope of the claims.

1. An actuator comprising:
a housing;
a combination motor and gear shaft secured in the housing;
a motor assembly in the housing, the motor assembly including a rotatable motor pinion mounted to the combination motor and gear shaft for rotation relative thereto, and a stator surrounding and spaced from the motor pinion;
a gear assembly including a first rotatable gear coupled to the motor pinion, a second rotatable gear mounted to the combination motor and gear shaft and coupled to the first rotatable gear, and a third rotatable gear coupled to the second rotatable gear and defining an aperture adapted to receive a rotatable shaft; and
a sensor assembly including a circuit board mounted in the housing.

2. The actuator of claim 1 wherein the motor pinion includes a shaft with gear teeth, and each of the first and second gears includes a wheel with gear teeth and a shaft with gear teeth, and the third gear is a sector gear with gear teeth, the gear teeth on the shaft of the motor pinion being coupled to the gear teeth on the wheel of the first gear, the gear teeth on the shaft of the first gear being coupled to the gear teeth on the wheel of the second gear and the gear teeth on the shaft of the second gear being coupled to the teeth on the sector gear.

3. The actuator of claim 1 wherein the circuit board is located in the housing between the stator of the motor assembly and the first gear.

4. The actuator of claim 1 wherein the motor pinion includes a motor magnet and a yoke molded therein.

5. The actuator of claim 1 wherein the first gear is mounted to a gear shaft which is mounted in the housing.

6. The actuator of claim 1 further comprising a pair of washers and a bushing for mounting the third gear for rotation in the interior of the housing.

7. An actuator comprising:
a housing;
a stationary shaft in the housing;
a motor in the housing including a stator and a motor pinion mounted for rotation on the shaft in the housing, the stator surrounding the motor pinion;
a gear mounted for rotation on the stationary shaft in the housing; and
a sensor assembly in the housing.

8. The actuator of claim 7 wherein the motor pinion includes a yoke, a motor magnet surrounding the yoke, and a sensor magnet.

9. The actuator of claim 8 wherein the yoke and the motor magnet are molded in a bracket on the motor pinion and the sensor magnet is seated on the bracket.

10. The actuator of claim 7 comprising first, second, and third rotatable gears in the housing, the gear comprising the second rotatable gear, the first rotatable gear being located in the housing on one side of the shaft and coupled to the motor pinion and the second rotatable gear, the third rotatable gear located in the housing on another side of the shaft and coupled to the second rotatable gear.

11. The actuator of claim 10 wherein each of the first and second rotatable gears includes a gear wheel and a collar and the motor pinion includes a shaft, the gear wheel of the first gear being coupled to the shaft of the motor pinion and the gear wheel of the second gear being coupled to the collar of the first gear, the third rotatable gear being coupled to the collar of the second gear.

12. The actuator of claim 8 wherein the sensor assembly includes a substrate with a sensor, the sensor being located in a relationship opposite and spaced from the sensor magnet on the motor pinion.

13. The actuator of claim 12 wherein the motor pinion includes a shaft, the shaft extending through an opening defined in the substrate.

14. The actuator of claim 10 wherein the first, second, and third rotatable gears are all located in the housing above the substrate.
